(19) United States
(12) Patent Application Publication
(10) Pub. No.: US 2012/0323864 A1
(43) Pub. Date: Dec. 20, 2012

(54) DISTRIBUTED DE-DUPLICATION SYSTEM AND PROCESSING METHOD THEREOF

(75) Inventors: Ming-Sheng ZHU, Tianjin (CN); Hui WANG, Tianjin (CN); Chih-Feng CHEN, Taipei (TW)

(73) Assignee: INVENTEC CORPORATION, Taipei (TW)

(21) Appl. No.: 13/240,360

(22) Filed: Sep. 22, 2011

(30) Foreign Application Priority Data
Jun. 17, 2011 (CN) 201110172532.X

(51) Int. Cl. G06F 17/30

(52) U.S. Cl. 707/692; 707/E17.005

(57) ABSTRACT

A distributed de-duplication system and a processing method thereof are described. A client runs a de-duplication procedure on an input file to generate a partitioned data block and a corresponding fingerprint eigenvalue. The client sends an inquiry request having the fingerprint eigenvalue to a dispatch server. The dispatch server records a storage location of the partitioned data block. The dispatch server forwards the inquiry request to the corresponding dedup. engine according to the fingerprint eigenvalue. The dedup. engine judges whether the fingerprint eigenvalue already exists. If the fingerprint eigenvalue does not exist, the dedup. engine stores a new partitioned data block to a storage server according to a new fingerprint eigenvalue.

### CROSS-REFERENCE TO RELATED APPLICATIONS

This non-provisional application claims priority under 35 U.S.C. §119(a) on Patent Application No. 201110172532.X filed in China, P. R. C. on Jun. 17, 2011, the entire contents of which are hereby incorporated by reference.

### BACKGROUND OF THE INVENTION

1. Field of the Invention

The present invention relates to a de-duplication system and a method thereof, and more particularly to a distributed de-duplication system and a processing method thereof.

2. Related Art

Along with the popularization of network, many network providers provide storage spaces on the network for effectively storing files of users. Usually, a single server is used to provide storage services of the network space. However, the operational capability of the single server is limited, and then multiple servers are used to provide the storage services in a parallel processing manner. The storage manner is referred to as the distributed storage system.

FIG. 1 is a schematic view of storing data in the prior art. Generally speaking, a distributed storage system is aimed to back up the complete data of the files of the users. Hence, different servers 121 may store the same data. For example, a distributed storage system has three storage servers 121. When a client 111 intends to store 100 Mbytes data to a network space, the distributed storage system respectively stores the 100 Mbytes in the three storage servers 121. In this manner, all the storage servers 121 occupy 300 Mbytes space. If the files of all the clients 111 are intended to be backed up in each storage server 121, it must be a heavy burden for the network providers.

### SUMMARY OF THE INVENTION

In view of the above problems, the present invention provides a distributed de-duplication system, for storing at least one partitioned data block generated by a client.

The distributed de-duplication system of the present invention comprises a client, a dispatch server, a dedup engine and a storage server. The client runs a de-duplication procedure on an input file and generates a partitioned data block and a corresponding fingerprint eigenvalue.

The dispatch server records a storage location of the partitioned data block of the input file. The dispatch server forwards an inquiry request to the corresponding dedup. engine according to the fingerprint eigenvalue. The dedup. Engine looks up the fingerprint hash table to find if a fingerprint eigenvalue already exists. If the fingerprint eigenvalue is not stored in the fingerprint hash table, the dedup. engine assigns a corresponding partitioned data block to a storage server according to the fingerprint eigenvalue and sends a storage node message with the assigned storage server to the client.

The fingerprint eigenvalue is generated from secure hash algorithm (SHA)-1, hash, or one way function, so that each partitioned data block is only corresponding to a unique fingerprint eigenvalue. After a new partitioned data block is stored in the storage server, the dedup. engine runs a synchronous process on the fingerprint hash table to update the fingerprint hash tables of other dedup. engines.

The present invention also provides a distributed de-duplication processing method, which comprises the following steps. After receiving the input file, the client generates a partitioned data block and sends an inquiry request having a fingerprint eigenvalue to a dispatch server. The dispatch server forwards the inquiry request to the corresponding dedup. engine according to the fingerprint eigenvalue. The dedup. engine judges whether the fingerprint eigenvalue already exists in the fingerprint hash table. If the fingerprint eigenvalue is not stored in the fingerprint hash table, the dedup. engine assigns a corresponding partitioned data block to a storage server according to the fingerprint eigenvalue and sends a storage node message with the assigned storage server to the client. The client transfers the partitioned data block to the storage server according to the storage node message.

In the distributed de-duplication system and the method of the present invention, layered assignment and duplicated data comparison are performed, so that the data volume of each data storage server can be effectively reduced, thereby improving the overall storage space of the data volume.

### BRIEF DESCRIPTION OF THE DRAWINGS

The present invention will become more fully understood from the detailed description given herein below for illustration only, and thus are not limitative of the present invention, and wherein:

FIG. 1 is a schematic view of storing data in the prior art;

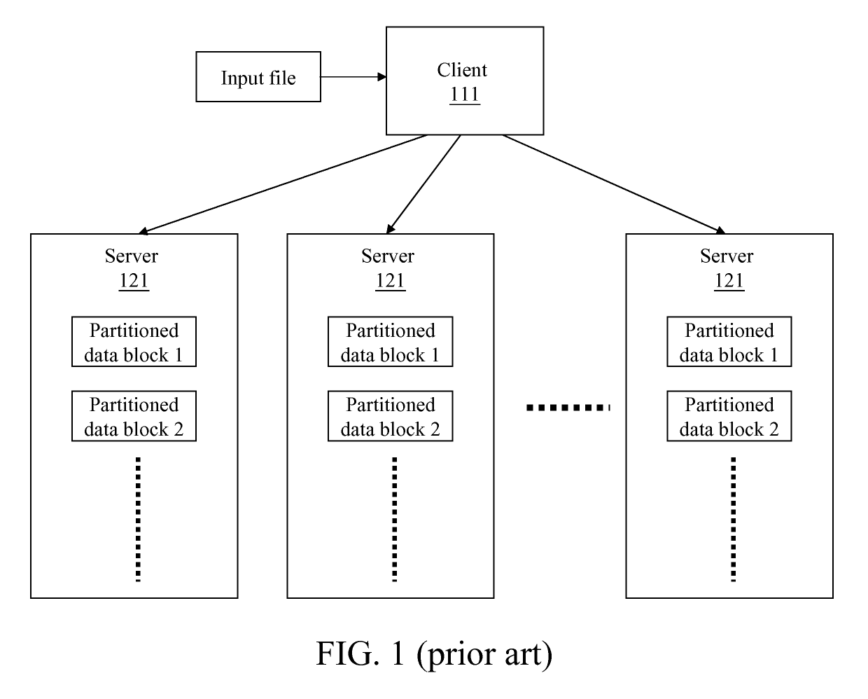

FIG. 2 is a schematic view of architecture of the present invention; and

FIG. 3 is a schematic view of an operation flow of the present invention.

### DETAILED DESCRIPTION OF THE INVENTION

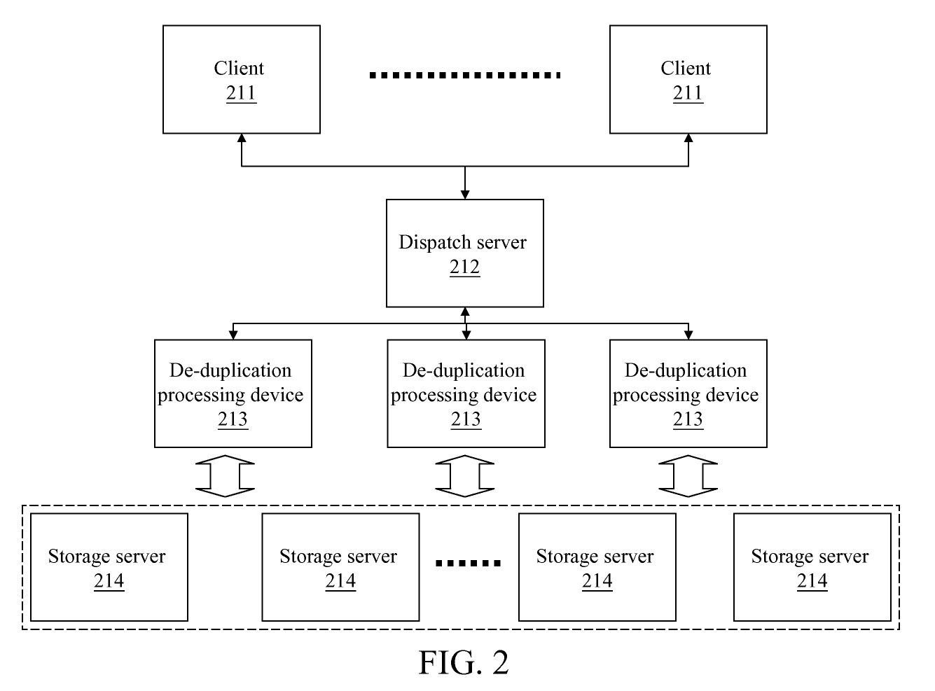

FIG. 2 is a schematic view of architecture of the present invention. A distributed de-duplication system of the present invention is applicable to a local area network or internet. The distributed de-duplication system of the present invention comprises: a client 211, a dispatch server 212, a dedup. engine 213 and a storage server 214. The client 211 is configured to receive an input file and carry out a partitioning process on the input file for judging de-duplication.

De-duplication is a data reduction technology and generally used for a disk-based backup system for the main purpose of reducing storage capacity used in a storage system. A working mode of the de-duplication is searching for duplicated data blocks of viable sizes (defined as partitioned data blocks in the present invention) at different locations in different files within a certain period of time. The duplicated data blocks may be replaced with a token. The de-duplication technology can be adopted to obtain more backup space, so that not only can backup data in the storage server 214 be saved for a longer time, but also a large amount of bandwidth required in the process of off-line storing can be conserved.

In the course of the de-duplication, the client 211 carries out a partitioning process on the input file. The input file after the partitioning process may generate multiple partitioned data blocks. Then, the client 211 carries out a hash process on the data block and generates a hash value corresponding to each data block. The client 211 compares the obtained hash value with the hash value stored in the storage server 21 and judges whether the hash values are identical. If the identical hash values exist, it indicates that the data block has been stored in the storage server 21.

After the client 211 of the present invention finishes the data partitioning process, the client 211 generates the partitioned data blocks corresponding to the input file and the fingerprint eigenvalues thereof. The fingerprint eigenvalue is generated from SHA-1, hash or one way function, so that each partitioned data block is only corresponding to a unique fingerprint eigenvalue. The client 211 sends an inquiry request having the fingerprint eigenvalue to a dispatch server 212.

The dispatch server 212 forwards the inquiry request to a corresponding de-duplication processing device according to the fingerprint eigenvalue, and the dispatch server 212 may further record a storage location of the partitioned data block of the input file. The number of the de-duplication processing devices is determined by the number of the client 211. Each dedup. engine 213 may further comprise a fingerprint hash table for recording the fingerprint eigenvalue corresponding to each partitioned data block. The dedup. engine 213 after receiving the fingerprint eigenvalue may judge whether the fingerprint eigenvalue already exists. When the fingerprint hash table does not comprise the inquired fingerprint eigenvalue, the de-duplication processing device selects any storage server 214 to store the corresponding partitioned data block.

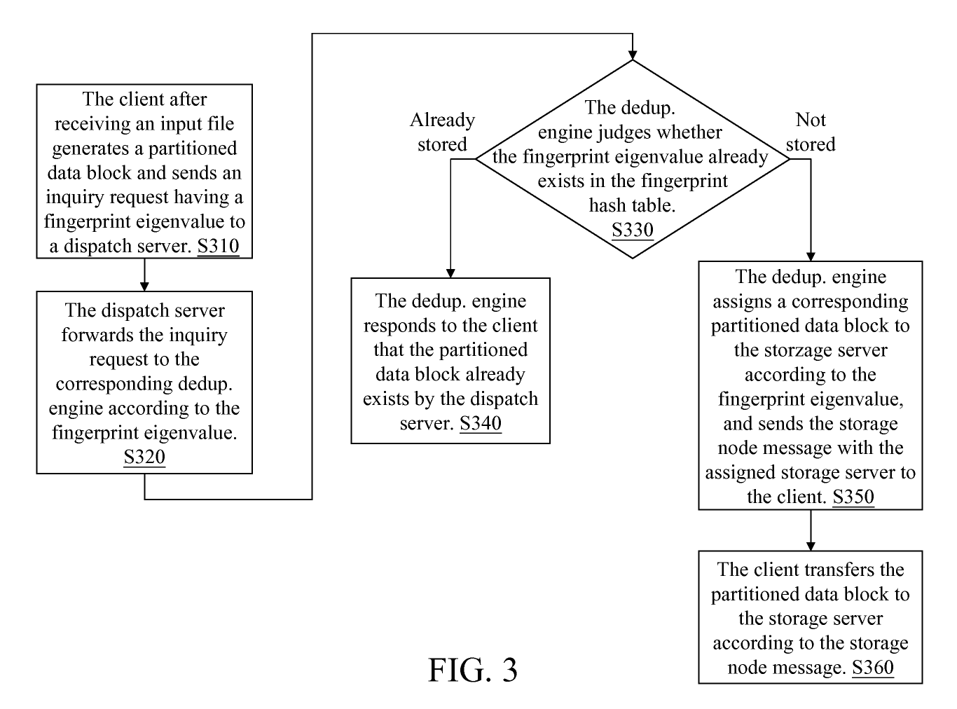

To clearly explain the operation process of the present invention, reference is made to FIG. 3. FIG. 3 is a schematic view of an operation flow of the present invention, in which the present invention comprises the following steps.

Step S310: The client after receiving an input file generates a partitioned data block and sends an inquiry request having a fingerprint eigenvalue to a dispatch server.

Step S320: The dispatch server forwards the inquiry request to the corresponding dedup. engine according to the fingerprint eigenvalue.

Step S330: The dedup. engine judges whether the fingerprint eigenvalue already exists in the fingerprint hash table.

Step S340: If the fingerprint eigenvalue is already stored in the fingerprint hash table, the dedup. engine responds to the client that the partitioned data block already exists by the dispatch server.

Step S350: If the fingerprint eigenvalue is not stored in the fingerprint hash table, the dedup. engine assigns a corresponding partitioned data block to the storage server according to the fingerprint eigenvalue, and sends the storage node message with the assigned storage server to the client.

Step S360: The client transfers the partitioned data block to the storage server according to the storage node message.

The client 211 receives the input file and carries out a partitioning process to generate a partitioned data block. The client 211 transfers an inquiry request having a fingerprint eigenvalue to a dispatch server 212. The dispatch server 212 forwards the inquiry request to the corresponding dedup. engine 213 according to the fingerprint eigenvalue. The dedup. engine 213 may carry out a mod process according to the fingerprint eigenvalue and forwards the inquiry request to the dispatch server 212 according to a result of the mod process.

For example, the client 211 carries out a partitioning process on the input file to form 1024 batches of partitioned data block, and SHA-1 generates corresponding fingerprint eigenvalues (that is, 1024 batches) for the partitioned data blocks. It is assumed that the number of the dispatch servers 212 is 3, a mod process is performed on the 1024 batches of fingerprint eigenvalues (that is, mod 3). In the practical operation, the mod parameter may be determined according to the number of the dispatch servers 212. Then, the inquiry request is forwarded to the corresponding dedup. engine 213 according to the result of mod. For example, the inquiry request for the fingerprint eigenvalue with a remainder of “0” is forwarded to the first dedup. engine 213, the inquiry request for the fingerprint eigenvalue with a remainder of “1” is forwarded to the second dedup. engine 213, and the inquiry request for the fingerprint eigenvalue with a remainder of “2” is forwarded to the third dedup. engine 213.

Then, after receiving the inquiry request, the dedup. engine 213 looks up the fingerprint hash table to find whether the fingerprint eigenvalue already exists. If the fingerprint eigenvalue has been stored in the fingerprint hash table, the dedup. engine 213 responds to the client 211 that the partitioned data block already exists by the dispatch server 212. Otherwise, the dedup. engine 213 assigns a corresponding partitioned data block to the storage server 214 according to the fingerprint eigenvalue and sends a storage node message that comprises the assigned storage server 214 to the client 211. The method of informing the client 211 comprises that the dispatch server 212 forwards the inquiry request to the corresponding dedup. engine 213 and then sends a storage node message to the client 211. Alternatively, the dispatch server 212 forwards the inquiry request to the corresponding dedup. engine 213 and then the dedup. engine 213 sends a storage node message to the client 211.

Furthermore, the dedup. engine 213 additionally records metadata information of the partitioned data block. The metadata information is used to maintain the storage location and length of the partitioned data block at the storage server. When the client 211 needs to read the partitioned data block, the dedup. engine 213 may find the location of the corresponding partitioned data block through the metadata information and perform reading, and meanwhile may confirm the correctness of the partitioned data block through the fingerprint eigenvalue.

Finally, when the client 211 receives the storage node message with the assigned storage location, the client 211 transfers the partitioned data block to the storage server 214 according to the storage node message. At the same time, the dedup. engine 213 carries out the synchronous process of the fingerprint hash table to update the fingerprint eigenvalue and the storage location of the corresponding partitioned data block recorded in the fingerprint hash tables of other dedup. engines 213. When other dedup. engines 213 receive the inquiry request of the stored partitioned data block, the dedup. engine 213 instantly judges whether the partitioned data block already exists.

In the distributed de-duplication system and the method of the present invention, layered assignment and duplicated data comparison are performed, so that the data volume of each data storage server can be effectively reduced, thereby improving the overall storage space of the data volume.

What is claimed is:

1. A distributed de-duplication system, for storing at least one partitioned data block generated by a client, the de-duplication system comprises:
at least a storage server, configured to store the partitioned data blocks;
a client, configured to run a de-duplication procedure on an input file, generate the partitioned data blocks and a corresponding fingerprint eigenvalue, send an inquiry request having the fingerprint eigenvalue, and transfer the partitioned data blocks to the storage server according to a storage node message;
a dedup. engine, configured to judge whether the fingerprint eigenvalue already exists and assign a new partitioned data block to the storage server according to a new the fingerprint eigenvalue; and
a dispatch server, configured to record a storage location of the partitioned data blocks of the input file and forward the inquiry request to the corresponding dedup. engine according to the fingerprint eigenvalue.

2. The distributed de-duplication system according to claim 1, wherein the dedup. engine carries out a mod process on the fingerprint eigenvalue and forwards the inquiry request to the dispatch server according to a result of the mod process.

3. The distributed de-duplication system according to claim 1, wherein after the dispatch server forwards the inquiry request to the corresponding dedup. engine, the dispatch server sends the storage node message to the client.

4. The distributed de-duplication system according to claim 1, wherein after the dispatch server forwards the inquiry request to the corresponding dedup. engine, the dedup. engine sends the storage node message to the client.

5. The distributed de-duplication system according to claim 1, wherein the dedup. engine additionally records metadata information of the partitioned data block.

6. The distributed de-duplication system according to claim 1, wherein after the storage server stores the partitioned data blocks, the dedup. engines run a synchronous process of a fingerprint hash table to update the fingerprint hash tables of other dedup. engines.

7. A distributed de-duplication processing method, for storing at least one partitioned data block generated by a client, the processing method comprises:
after the client receives an input file, generating, by the client, the partitioned data blocks and sending an inquiry request having a fingerprint eigenvalue to a dispatch server;
forwarding, by the dispatch server, the inquiry request to a corresponding dedup. engine according to the fingerprint eigenvalue;
judging, by the dedup. engine, whether the fingerprint eigenvalue already exists in a fingerprint hash table;
if the fingerprint eigenvalue is not stored in the fingerprint hash table, assigning, by the dedup. engine, the corresponding partitioned data block to the storage server according to the fingerprint eigenvalue and sending a storage node message with the assigned storage server to the client; and
transferring, by the client, the partitioned data block to the storage server according to the storage node message.

8. The distributed de-duplication processing method according to claim 7, wherein the dedup. engine carries out a mod process on the fingerprint eigenvalue and forwards the inquiry request to the dispatch server according to a result of the mod process.

9. The distributed de-duplication processing method according to claim 7, wherein the dedup. engine additionally records metadata information of the partitioned data block.
